(19) United States
(12) Patent Application Publication
(10) Pub. No.: US 2010/0073578 A1
(43) Pub. Date: Mar. 25, 2010

(54) IMAGE DISPLAY DEVICE AND POSITION DETECTING METHOD

(75) Inventor: Xiaodi Tan, Saitama (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/557,225

(22) Filed: Sep. 10, 2009

(30) Foreign Application Priority Data
Sep. 19, 2008 (JP) 2008-240245

(51) Int. Cl. H04N 9/31; G03B 21/00

(52) U.S. Cl. 348/744; 353/31; 348/E09.025

(57) ABSTRACT

The present invention provides an image display device allowing accurate detection of a pointed position on a projection image to be achieved. The image display device include: an image light generating section generating image light based on an input video signal; a projecting section projecting the image light onto a screen to form a projection image; a reflection light splitting section splitting part of reflection light of the projection image from the screen to another direction; a light receiving section receiving the split light; an image generating/obtaining section generating a display image from the video signal and obtaining the projection image corresponding to the inputted video signal from the light receiving section; a position detecting section detecting a position pointed out on the projection image as a pointed position based on the display image and the projection image to output information of the pointed position on the projection image.

### BACKGROUND OF THE INVENTION

1. Field of the Invention

The present invention relates to an image display device and a position detecting method, for detecting a position on an image pointed out with a laser pointer, a pointing stick, a finger or the like.

2. Description of the Related Art

At present, there are various methods for operating a computer. Other than a keyboard and a mouse, for example, there are direct-input-type displays in various modes for operating a computer by touching a screen with a finger, a dedicated pen, or the like. The displays of the direct-input type are called touch panels or touch screens (hereinbelow, generically called touch screens). The touch screen is an output interface and also plays a role as a main input interface such as a keyboard and a mouse.

There is a case that the touch screen is provided with a connection terminal such as RS-232, PS/2, USB, or the like. In the case where the touch screen is provided with such a connection terminal, the user may easily connect the touch screen and a computer as in the case of a keyboard and a mouse. In addition, since the touch screen is easily used in such a manner that the user may perform the same operation as that with the mouse only by making the touch screen touched with a finger, a dedicated pen, or the like, there are many cases recently that a program structure is developed for the touch screen. Further, because the touch screen makes it easy to regulate the user to press fixed keys unlike the keyboard and the mouse, the touch screen is suitable for an unattended interactive system such as a guest guidance system, an automatic tutoring system, or the like.

In the case of a projector, however, an input interface cannot be provided for an image displaying screen itself. Thus, for example, when the user makes a presentation while pointing a predetermined position in the screen with a laser pointer, a pointing stick, a finger, or the like, the user has to move to a position in front of a personal computer to operate the personal computer. As a result, the user has to move between the screen and the personal computer repeatedly during the presentation. Therefore, there has been a problem that the presentation using the projector cannot be performed smoothly.

In view of this problem, a number of countermeasures to eliminate the necessity of directly operating a personal computer have been proposed. For example, each of Japanese Unexamined Patent Application Publication Nos. 2001-109577, H05-22436, and 2001-290600 proposes to cause reflection light from a screen light to pass through an optical filter which selectively transmits a wavelength band of light output from a laser pointer, detect a position pointed out with the laser pointer from the transmission light, and utilize information on the detected position to operate a personal computer. Also, for example, Japanese Unexamined Patent Application Publication No. 2003-173236 proposes to sense reflection light from a screen by a four-divided sensor, detect a shift of a light spot in the screen, and utilize information on the shift of the light spot to operate a personal computer.

### SUMMARY OF THE INVENTION

However, in the methods disclosed in JP2001-109577A, JP-H05-22436A and JP2001-290600A, there is a case that light of the laser pointer included in the reflection light from the screen cannot be extracted well by the optical filter, due to wavelength fluctuations at the time of reflection at the screen. Also, in the method disclosed in JP-H05-22436A, the laser pointer which emits light having a wavelength out of the visible region is used. Therefore, the position on the screen irradiated with the light, output from the laser pointer and having the wavelength out of the visible region, cannot be figured out, so that operability is low. Further, the light having the wavelength out of the visible region is invisible, and thus there is a danger that the light output from the laser pointer accidentally enters the eye. Also, in the method disclosed in JP2003-173236A, only the shift of the light spot in the screen is known, so that accuracy and resolution are low. Moreover, in the methods disclosed in these proposals, only the laser pointer is inherently usable.

It is therefore desirable to provide an image display device and a position detecting method capable of accurately detecting a position on an image pointed out with a laser pointer, a pointing stick, a finger, or the like, regardless of an external factor.

An image display device according to an embodiment of the present invention includes: an image light generating section generating image light based on an input video signal; a projecting section projecting the image light onto a screen to form a projection image; a reflection light splitting section transmitting the image light from the image light generating section and splitting part of reflection light of the projection image from the screen to a direction crossing the axis of the projecting section; a light receiving section receiving light split by the reflection light splitting section; an image generating/obtaining section generating a display image from the video signal and obtaining the projection image corresponding to the inputted video signal from the light receiving section; a position detecting section detecting a position pointed out on the projection image as a pointed position based on the display image and the projection image; and an output section outputting information of the pointed position on the projection image.

A position detecting method according to an embodiment of the present invention includes the steps of: projecting image light based on an input video signal onto a screen to form a projection image, splitting part of reflection light of the projection image from the screen to another direction, and then receiving split light; generating a display image from the video signal and obtaining the projection image corresponding to the inputted video signal from split light; and detecting a position pointed out on the projection image as a pointed position based on the display image and the projection image, to output information of the pointed position on the projection image.

In the image display device and the position detecting method according to the embodiments of the present invention, the display image generated from the video signal and the projection image obtained by the light receiving section corresponding to the inputted video signal are used to detect the position on the projection image as the pointed position. Thereby, the position on the projection image as the pointed position is detected regardless of the kind of the pointed position (for example, a light spot, a pointing stick, or a finger) and an external factor.

In the image display device and the position detecting method according to the embodiments of the present invention, the display image and the projection image are used to detect the position on the projection image as the pointed position. Therefore, the position on an image pointed out with the laser pointer, the pointing stick, the finger, or the like is capable of being accurately detected regardless of the external factor.

Other and further objects, features and advantages of the invention will appear more fully from the following description.

### BRIEF DESCRIPTION OF THE DRAWINGS

FIG. 1 is a schematic diagram illustrating an example of a general configuration of an image display system provided with an image display device according to a first embodiment of the present invention.

FIG. 2 is a schematic diagram illustrating an example of an internal configuration of a projector in FIG. 1.

FIG. 3 is a schematic diagram illustrating an example of an internal configuration of a control section in FIG. 2.

FIG. 4 is a flowchart illustrating an example of operation of the image display system in FIG. 1.

FIG. 5 is a schematic diagram illustrating an example of a general configuration of an image display system according to a second embodiment of the present invention.

FIG. 6 is a schematic diagram illustrating an example of an internal configuration of a projector in FIG. 5.

FIG. 7 is a schematic diagram illustrating an example of an internal configuration of a control section in FIG. 6.

FIG. 8 is a flowchart illustrating an example of operation of the image display system in FIG. 7.

FIG. 9 is a schematic diagram illustrating a modification of a laser pointer in the image display system in FIG. 5.

FIG. 10 is a schematic diagram illustrating another modification of the laser pointer in the image display system in FIG. 5.

### DETAILED DESCRIPTION OF THE PREFERRED EMBODIMENTS

Embodiments of the present invention will be described in detail hereinbelow with reference to the drawings.

### First Embodiment

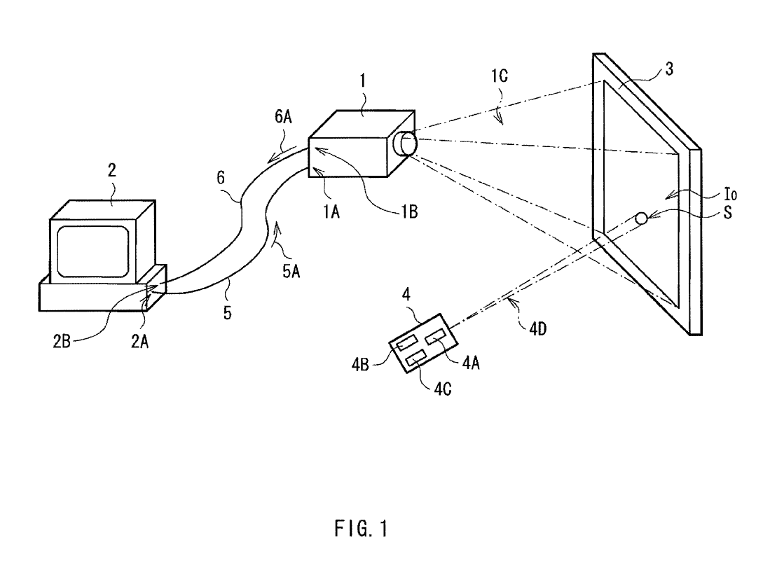

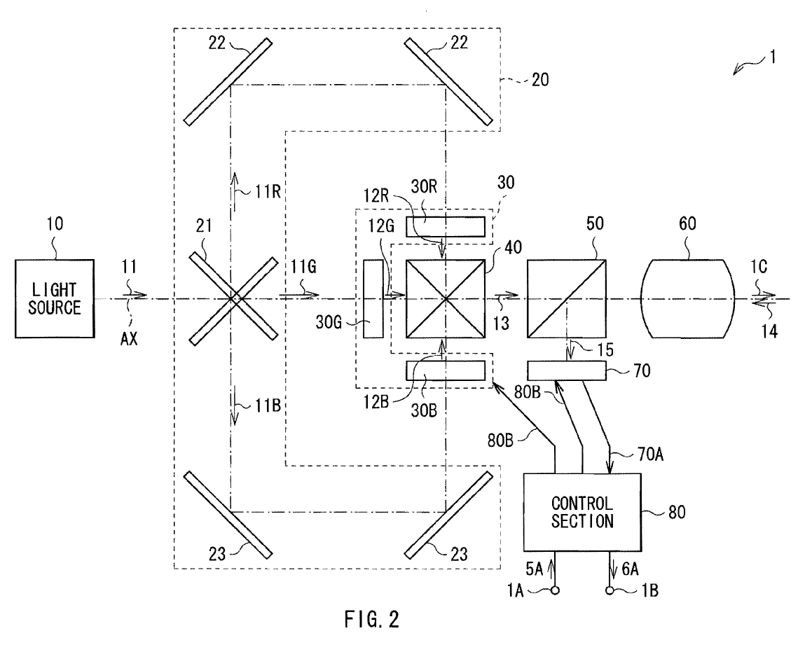

FIG. 1 illustrates an example of a schematic configuration of an image display system having a projector 1 (image display device) according to a first embodiment of the present invention. FIG. 2 illustrates an example of an internal configuration of the projector 1. The image display system projects, for example, an image displayed on a screen of an information processing unit 2 onto a screen 3 by using the projector 1, and allows the screen 3 to be used substantially as a touch screen by operating a laser pointer 4 like a mouse or a computer mouse (not illustrated) of the information processing unit 2.

The projector 1 projects the image displayed on the screen of the information processing unit 2 onto the screen 3. The projector 1 is provided with two terminals (an input terminal 1A and an output terminal 1B). To the input terminal 1A, a video signal line 5 is connected. A video signal 5A output from the information processing unit 2 is input to the input terminal 1A via the video signal line 5. To the output terminal 1B, an operation signal line 6 is connected. An operation signal 6A is output from the output terminal 1B. Each of the input terminal 1A and the output terminal 1B is, for example, an RS-232, PS/2, USB, or the like. The internal configuration of the projector 1 will be described in detail later.

The information processing unit 2 is capable of displaying a desired image on the screen by an operation of the user and is, for example, a personal computer. The information processing unit 2 is also provided with two terminals (an output terminal 2A and an input terminal 2B). To the output terminal 2A, the video signal line 5 is connected. The video signal 5A is output from the output terminal 2A by an operation of the user. To the input terminal 2B, the operation signal line 6 is connected. The operation signal 6A output from the projector 1 is input to the input terminal 2B. Each of the input terminal 2B and the output terminal 2A is, for example, an RS-232, PS/2, USB, or the like.

On the screen 3, projection light IC output from the projector 1 is projected to display a projection image Io. The screen 3 may be, for example, a commercially-available fabric or an inner wall in a room. The laser pointer 4 has therein a semiconductor laser device (not illustrated) for outputting a laser beam 4D including visible light to generate a light spot S on the screen 3, and an event signal generating unit for modulating the output of the semiconductor laser device in accordance with one or more kinds of event signals. The semiconductor laser device has an output button 4A. When the output button 4A is pressed, the laser beam 4D is output. The event signal generating unit is provided with, for example, a left event button 4B and a right event button 4C. When the left event button 4B is pressed once, the event signal generating unit outputs to the semiconductor laser device a signal for controlling the semiconductor laser device so as to perform predetermined modulation. When the left event button 4B is pressed twice successively, the event signal generating unit outputs a signal for controlling the semiconductor laser device so as to perform modulation different from the other modulation to the semiconductor laser device. When the right event button 4C is pressed once, the event signal generating unit outputs a signal for controlling the semiconductor laser device so as to perform modulation different from the other modulation to the semiconductor laser device. Modulation here refers to, for example, temporal modulation or spatial modulation on brightness distribution in plane of the light spot S, frequency modulation of the laser beam 4D, and the like. It is to be noted that there are various ways to press the left event button 4B and the right event button 4C. Other than the above-described ways, for example, there is also a way to keep on pressing the left event button 4B.

Next, the internal configuration of the projector 1 will be described. The projector 1 is, for example, a triple-plate transmissive projector and has, for example, as illustrated in FIG. 2, a light source 10, an optical path splitter 20, a spatial light modulator 30, a synthesizer 40, a reflection light splitting section 50, a projecting section 60, a light receiving section 70, and a control section 80. The light source 10, the optical path splitter 20, the spatial light modulator 30, the synthesizer 40, and the control section 80 in the present embodiment correspond to one concrete example of an “image light generating section” of the present invention.

The light source 10 supplies a light flux for irradiating a surface to be irradiated of the spatial light modulator 30, and includes, for example, a lamp of a white light source and a reflecting mirror formed at the back of the lamp. As necessary, the light source 10 may have some optical device in a region (on the optical axis AX) through which light 11 of the lamp passes. For example, a filter for reducing light other than visible light in the light 11 from the lamp, and an optical integrator for uniforming an illuminance distribution on the surface to be irradiated of the spatial light modulator 30 may be provided in this order from a side of the lamp on the optical axis AX of the lamp.

The optical path splitter 20 separates the light 11 output from the light source 10 to a plurality of color beams in different wavelength bands, and guides the color beams to the surface to be irradiated of the spatial light modulator 30 and includes, for example, as illustrated in FIG. 2, one cross mirror 21 and four mirrors 22. The cross mirror 21 separates the light 11 output from the light source 10 to a plurality of color beams in different wavelength bands and also splits the optical path of each color beam. The cross mirror 21 is disposed, for example, on the optical axis AX, and is structured by coupling two mirrors having different wavelength-selectivity properties so as to cross each other. The four mirrors 22 reflect the color beams (in FIG. 2, red light 11R and blue light 11B) whose optical paths are split by the cross mirror 21, and are disposed in places different from the optical axis AX. Two mirrors 22 out of the four mirrors 22 are disposed to guide light (red light 11R in FIG. 2) reflected to one direction crossing the optical axis AX by one mirror included in the cross mirror 21 to the surface to be irradiated of a spatial light modulator 30R which will be described later. The remaining two mirrors 22 out of the four mirrors 22 are disposed to guide light (blue light 11B in FIG. 2) reflected to another direction crossing the optical axis AX by the other mirror included in the cross mirror 21 to the surface to be irradiated of a spatial light modulator 30B which will be described later. Light (green light 11G in FIG. 2) passing through the cross mirror 21 in the light 11 output from the light source 10 and passing along the optical axis AX is incident on the surface to be irradiated of a spatial light modulator 30G (described later) disposed on the optical axis AX.

The spatial light modulator 30 modulates each of the plurality of color beams in accordance with a modulation signal 80A input from the control section 80 to generate modulation light of each color beam. The spatial light modulator 30 includes, for example, the spatial light modulator 30R for modulating the red light 11R, the spatial light modulator 30G for modulating the green light 11G, and the spatial light modulator 30B for modulating the blue light 11B. The spatial light modulator 30R is, for example, a transmissive liquid crystal panel, and is disposed in a region facing one of faces of the synthesizer 40. The spatial light modulator 30R modulates the incident red light 11R on the basis of the modulation signal 80A to generate red image light 12R, and outputs the red image light 12R to one of the faces of the synthesizer 40 at the back of the spatial light modulator 30R. The spatial light modulator 30G is, for example, a transmissive liquid crystal panel, and is disposed in a region facing other face of the synthesizer 40. The spatial light modulator 30G modulates the incident green light 11G on the basis of the modulation signal 80A to generate green image light 12G, and outputs the green image light 12G to other face of the synthesizer 40 at the back of the spatial light modulator 30R. The spatial light modulator 30B is, for example, a transmissive liquid crystal panel, and is disposed in a region facing other face of the synthesizer 40. The spatial light modulator 30B modulates the incident blue light 11B on the basis of the modulation signal 80A to generate the blue image light 12B, and outputs the blue image light 12B to other face of the synthesizer 40 at the back of the spatial light modulator 30R.

The synthesizer 40 synthesizes the plurality of modulation light pieces to generate image light. The synthesizer 40 is disposed, for example, on the optical axis AX, and is, for example, a cross prism structured by joining four prisms. In the joined face of the prisms, for example, two selective-reflection faces having different wavelength-selectivity properties are formed by multilayer interference films or the like. One of the selective-reflection faces reflects, for example, the red image light 12R output from the spatial light modulator 30R to a direction parallel with the optical axis AX, and guides the same toward the projecting section 60. The other selective-reflection face reflects, for example, the blue image light 12B output from the spatial light modulator 30B to a direction parallel with the optical axis AX, and guides the same toward the projecting section 60. The green image light 12G output from the spatial light modulator 30G passes through the two selective-reflection faces, and travels toward the projecting section 60. As a result, the synthesizer 40 functions to synthesize the red image light 12R, the green image light 12G, and the blue image light 12B generated by the spatial light modulators 30R, 30G, and 30B, respectively, to generate image light 13, and to output the generated image light 13 to the projecting section 60.

The projecting section 60 projects the image light 13 output from the synthesizer 40 onto the screen 3 (see FIG. 1) to display an image. The projecting section 60 is disposed, for example, on the optical axis AX and is structured by, for example, a projection lens.

The reflection light splitting section 50 transmits the image light 13, reflects a part of reflection light 14 reflected from the screen 3 side (that is, an image on the screen 3 visually recognized by the observer) to a direction crossing the optical axis AX, and guides the same to a light incidence surface of the light receiving section 70. The “part of the reflection light 14” mentioned above does not refer to a spatial part, but refers to, for example, one of two polarization components included in the reflection light 14, a part of the total amount of the reflection light 14, and the like. The reflection light splitting section 50 is disposed, for example, between the synthesizer 40 and the projecting section 60, and is, for example, a beam splitter structured by joining two prisms. From the viewpoint of effectively utilizing the light amount, the beam splitter is preferably a polarized beam splitter having a polarization split surface on the interface between the two prisms. The polarization split surface splits, for example, the incident reflection light 14 into two polarization components orthogonal to each other, reflects one of the polarization components (for example, S-polarized component) to a direction crossing the optical axis AX, and transmits the other polarization component (for example, P-polarized component) to a direction parallel with the optical axis AX. The beam splitter may also be a general beam splitter including a reflection face having no polarization splitting function on the interface between the two prisms.

The light receiving section 70 is a two-dimensional image detector which receives the reflection light 15 reflected by the reflection light splitting section 50 and obtains the image on the screen 3 which is visually recognized by the observer. The light receiving section 70 outputs the obtained image as image light 70A to the control section 80 in accordance with a drive signal 80B from the control section 80. The light receiving section 70 includes, for example, a CCD (Charge Coupled Device) or a complementary metal oxide semiconductor. Preferably, the light incident face of the light receiving section 70 is disposed on an image surface of the screen 3. In such a case, the image on the screen 3 which is perceived by the observer is obtained most accurately by the light receiving section 70. Thus, in a position detecting process which will be described later, the position of the light spot S is detected extremely accurately.

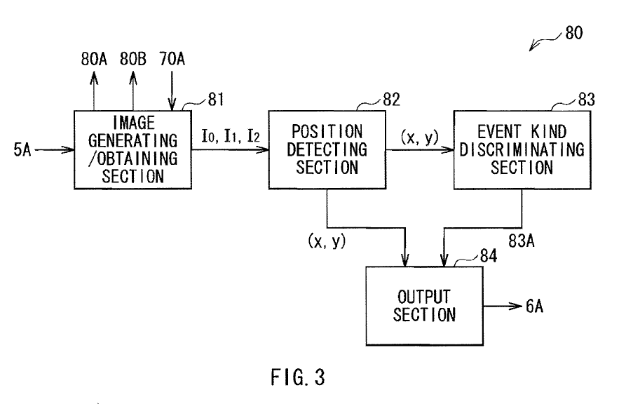

The control section 80 includes, for example, as illustrated in FIG. 3, four function blocks and has an image generating/obtaining section 81, a position detecting section 82, an event kind discriminating section 83, and an output section 84. In the control section 80, the four function blocks may be configured by hardware or a program.

The image generating/obtaining section 81, for example, generates a display image I₂ from the input video signal 5A. In addition, the image generating/obtaining section 81, when a peculiar signal corresponding to an image prepared by the user is input as the video signal 5A, outputs the modulation signal 80A according to the peculiar signal to the spatial light modulator 30, and obtains the projection image Io on the screen 3 which is visually recognized by the observer from the light receiving section 70, for example. As necessary, the image generating/obtaining section 81 further, for example, outputs an initial signal corresponding to a blank image irrespective or dependent of the input video signal 5A to the spatial light modulator 30, and obtains a background image I₁ on the screen 3 visually recognized by the observer from the light receiving section 70. The image generating/obtaining section 81 outputs the generated display image I₂, the obtained background image I₁, and the projection image Io to the position detecting section 82.

The position detecting section 82 retrieves or detects, for example, the position (x, y) on the projection image Io of a pointing part or a pointed position by using the projection image Io and the display image I₂ input from the image generating/obtaining section 81. The pointing part or the pointed position here refers to the light spot S formed by the laser beam 4D output from the laser pointer 4. The position (x, y) is retrieved, for example, by performing a binarizing process using a predetermined threshold on a differential image (image I₃ for position retrieval) obtained by calculating the difference between the display image I₂ and the projection image Io, and performing a predetermined process on a binary image obtained by the binarizing process. The position detecting section 82 outputs the image I₃ for position retrieval and the position (x, y) on the projection image Io of the light spot S to the event kind discriminating section 83, and also outputs the position (x, y) on the projection image Io of the light spot S to the output section 84.

As necessary, the position detecting section 82 may, for example, retrieve the position (x, y) on the projection image Io of the light spot S by using not only the projection image Io and the display image I₂ input from the image generating/obtaining section 81 but also the background image I₁. In this case, the position (x, y) is retrieved by, for example, performing a binarizing process using a predetermined threshold on a differential image (image I₃ for position retrieval) obtained by calculating the difference between an image derived by adding the background image I₁ to the display image I₂ and the projection image Io, and performing a predetermined process on a binary image obtained by the binarizing process. The position (x, y) may also be retrieved by, for example, performing a binarizing process using a predetermined threshold on a differential image (image I₃ for position retrieval) obtained by calculating the difference between the display image I₂ and an image derived by subtracting the background image I₁ from the projection image Io, and performing a predetermined process on a binary image obtained by the binarizing process.

The event kind discriminating section 83, when the position (x, y) on the projection image Io of the light spot S is detected by the position detecting section 82, discriminates the kind of an event on the basis of information in the position on the projection image Io of the light spot on the image I₃ for position retrieval, for example. The kind of an event is, for example, one press of the left event button 4B, two presses of the left event button 4B, one press of the right event button 4C, and the like. In addition, for example, information such as the temporal modulation or the spatial modulation on the brightness distribution in the plane of the light spot S, the frequency modulation of the laser beam 4D, or the like is included in the position corresponding to the position on the projection image Io of the light spot S on the image I₃ for position retrieval. Therefore, by obtaining a plurality of images 13 for position retrieval by using the projection image Io and the display image 12 obtained successively at predetermined time intervals, the information such as the temporal modulation or the spatial modulation on the brightness distribution in the plane of the light spot S, the frequency modulation of the laser beam 4D, or the like is obtained. The event kind discriminating section 83 outputs information 83A of the kind of an event obtained by the discrimination to the output section 84.

The output section 84, in the case where the position (x, y) on the projection image Io of the light spot S is detected by the position detecting section 82, outputs at least information of the position (x, y) on the projection image Io of the detected light spot S as the operation signal 6A. As necessary, in the case where the kind of an event is detected by the event kind discriminating section 83, the output section 84 may output, as the operation signal 6A, not only the information of the position (x, y) on the projection image Io of the detected light spot S but also the information 83A on the kind of the event obtained by the discrimination.

Preferably, the format of the operation signal 6A is the same as that of the mouse (not illustrated) of the information processing unit 2. For example, the output section 84 may generate the same signal as that of the left click of the mouse as the information of the kind of the event corresponding to the one press of the left event button 4B, generate the same signal as that of the left double click of the mouse as the information of the kind of the event corresponding to the two successive presses of the left event button 4B, and generate the same signal as that of the right click of the mouse as the information of the kind of the event corresponding to the one press of the right event button 4C. In such a case, the information processing unit 2 does not have to be previously provided with new hardware or software for recognizing the operation signal 6A. Thus, simplicity is sufficiently ensured. Meanwhile, from a viewpoint of decreasing the number of cables for connecting the projector 1 and the information processing unit 2, preferably, the video signal line 5 and the operation signal line 6 are integrated as a single cable, one input/output terminal is provided on the projector 1 side, and one input/output terminal is provided on the information processing unit 2 side. In this case, it may be desirable to provide new hardware or software for recognizing a signal output from the projector 1 in the information processing unit 2. It is also possible to separate a connector for a video and a connector for the mouse. In this case, new hardware or software does not have to be provided in the information processing unit 2.

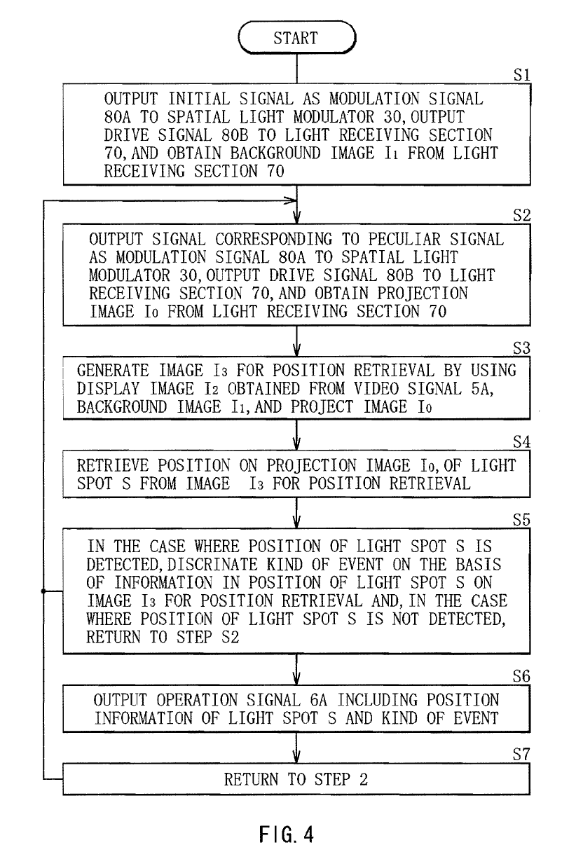

Next, with reference to FIG. 4, an example of the operation of the image display system according to the present embodiment will be described. FIG. 4 illustrates a case of using the background image I₁ as an example of a process of discriminating the position of the light spot S and the kind of the event in the image display system. It is to be noted that in a case where the background image I₁ is not used, step S1 which will be described later may be skipped and the image I₃ for position retrieval may be generated without using the background image I₁ in step S3 which will be described later.

First, the image generating/obtaining section 81 in the control section 80 outputs the initial signal corresponding to the blank image as the modulation signal 80A to the spatial light modulator 30 irrespective or dependent of the input video signal 5A, outputs the drive signal 80B to the light receiving section 70, and obtains the background image I₁ on the screen 3 visually recognized by the observer (step S1). At this time, the image generating/obtaining section 81 may synchronously output the modulation signal 80A and the drive signal 80B, or may output the modulation signal 80A and, after while, output the drive signal 80B. The background image I₁ may be obtained after lapse of predetermined time since the power source of the projector 1 is turned on, or when the peculiar signal corresponding to the image prepared by the user as the video signal 5A is received.

Then, when the peculiar signal corresponding to the image prepared by the user as the video signal 5A is input, the image generating/obtaining section 81 outputs a signal corresponding to the peculiar signal as the modulation signal 80A to the spatial light modulator 30, outputs the drive signal 80B to the light receiving section 70, and obtaining the projection image Io on the screen visually recognized by the observer from the light receiving section 70 (step S2). At this time, in the case where the video signal 5A temporarily fluctuates, preferably, the image generating/obtaining section 81 synchronously outputs the modulation signal 80A and the drive signal 80B. However, in the case where the video signal 5A does not temporarily fluctuate, the drive signal 80B may be output after a while, after the modulation signal 80A is output. When the modulation signal 80A and the drive signal 80B are synchronously output in the case where the video signal 5A temporarily fluctuates, the display image I₂ obtained from the video signal 5A and the projection image Io obtained by the light receiving section 70 are almost matched with each other except for the region where the light spot S and the like exists. That is, the difference between the display image I₂ and the projection image Io is calculated, the region where the light spot S and the like exists is clearly detected.

Then, when the peculiar signal corresponding to the image prepared by the user is input as the video signal 5A, the position detecting section 82 in the control section 80 obtains the display image I₂ from the peculiar signal, and thereafter generates the image I₃ for position retrieval by using the display image I₂, the background image I₁, and the projection image Io (step S3). For example, the position detecting section 82 generates the image I₃ for position retrieval, by calculating the difference between the image obtained by adding the background image I₁ to the display image I₂ and the projection image Io, by calculating the difference between the display image I₂ and the image obtained by subtracting the background image I₁ from the projection image Io, or the like.

Then, the position detecting section 82 in the control section 80 retrieves the position on the projection image Io of the light spot S from the image I₃ for position retrieval (step S4). For example, the position detecting section 82 retrieves the position on the projection image Io of the light spot S, by performing the binarizing process using a predetermined threshold on the image I₃ for position retrieval, and performing a predetermined process on a resulted binary image.

Then, in the case where the position (x, y) on the projection image Io of the pointing part is detected by the position detecting section 82, the event kind discriminating section 83 in the control section 80 discriminates the kind of an event, on the basis of the information in the position corresponding to the position on the projection image Io of the pointing part on the image I3 for position retrieval (step S5). For example, the event kind discriminating section 83 extracts the image in the position corresponding to the position on the projection image Io of the light spot S on the image I₃ for position retrieval, from the plurality of images I₃ for position retrieval obtained by using the projection images Io and the display images I₂ obtained successively at predetermined time intervals and by using the background image I₁, and obtains the information such as the temporal modulation or the spatial modulation on the brightness distribution, the frequency modulation of the laser beam 4D, or the like from the extracted images.

In the case where the position (x, y) on the projection image Io of the pointing part is not detected by the position detecting section 82, control of the control section 80 returns to the step S2 (step S5).

Next, in the case where the position (x, y) on the projection image Io of the light spot S is detected by the position detecting section 82, the output section 84 in the control section 80 outputs, as the operation signal 6A, at least the information of the position (x, y) on the projection image Io of the detected light spot S. In addition, in the case where the kind of an event is detected by the event kind discriminating section 83, the output section 84 in the control section 80 outputs, as the operation signal 6A, not only the information of the position (x, y) on the projection image Io of the detected light spot S but also the information 83A on the kind of the event obtained by the discrimination (step S6).

Thereafter, control of the control section 80 returns to the step S2 (step S7).

Subsequently, the information processing unit 2 performs a process based on the operation signal 6A input from the projector 1. Specifically, in the case where the information processing unit 2 has obtained, as the operation signal 6A, not only the information of the position (x, y) on the projection image Io of the detected light spot S but also the information 83A on the kind of the event obtained by the discrimination, the information processing unit 2 executes a function corresponding to the kind of the event from various functions defined in correspondence with the position (x, y) on the projection image Io. As a result, for example, the information processing unit 2 turns a page, executes the function assigned to an icon, or moves a mouse pointer to the position (x, y).

Accordingly, in the present embodiment, the screen 3 is capable of being used substantially as the touch screen by operating the laser pointer 4 like the mouse (not illustrated) of the information processing unit 2. Thus, for example, the user does not have to move to a position in front of a personal computer to operate the personal computer when the user makes a presentation while pointing a predetermined position in the screen with a laser pointer. Therefore, the user does not have to move between the screen and the personal computer repeatedly during the presentation. Hence, the user is able to smoothly perform the presentation in which the projector is used.

Also, in the present embodiment, it is possible to use the screen 3 substantially as the touch screen without changing the information processing unit 2 and the screen 3. Thus, general versatility and convenience are extremely high. In addition, the configuration of the projector 1 of the present embodiment is obtainable only by providing an existing projector with the reflection light splitting section 50, the light receiving section 70, and the control section 80. Therefore, upgrading is easy and the cost required for the upgrading is low.

### Second Embodiment

A second embodiment of the present invention will be described.

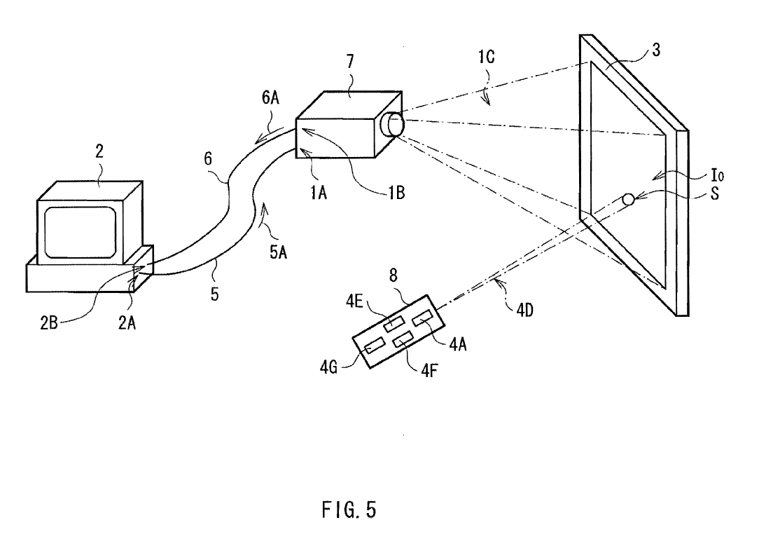

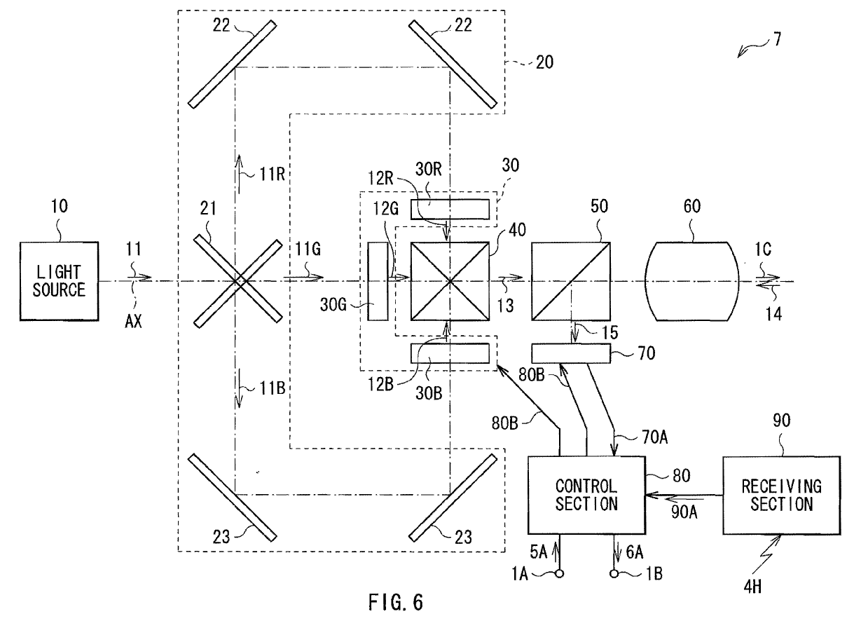

FIG. 5 illustrates an example of a schematic configuration of an image display system having a projector 7 (image display device) according to a second embodiment of the present invention. FIG. 6 illustrates an example of an internal configuration of the projector 7 in FIG. 5. The image display system projects, for example, an image displayed on a screen of the information processing unit 2 onto the screen 3 by using the projector 7, and allows the screen 3 to be used substantially as a touch screen by operating a laser pointer 8 like a mouse (not illustrated) of the information processing unit 2.

The projector 7 of the second embodiment is different from the configuration of the projector 1 of the foregoing embodiment, in that the projector 7 has a receiving section 90. Also, the laser pointer 8 of the second embodiment is different from the configuration of the laser pointer 4 of the foregoing embodiment, in that the laser pointer 8 has a left event button 4E, a right event button 4F, and a transmitting section 4G in place of the left event button 4B and the right event button 4C in the laser pointer 4 of the above embodiment. In the following, the points different from the foregoing embodiment will be mainly described, and the points common to the foregoing embodiment will not be described in detail.

The laser pointer 8 has therein, for example, a semiconductor laser device (not illustrated) for outputting the laser beam 4D including visible light to generate a light spot S on the screen 3, and an event signal generating unit for selectively generating one or more kinds of event signals. The semiconductor laser device has the output button 4A. When the output button 4A is pressed, the laser beam 4D is output. The event signal generating unit is provided with, for example, a left event button 4E, a right event button 4E, and a transmitting section 4G. When the left event button 4E is pressed once, the event signal generating unit outputs a predetermined event signal 4H from the transmitting section 4G. When the left event button 4E is pressed twice successively, the event signal generating unit outputs an event signal 4H different from the other signals from the transmitting section 4G. When the right event button 4F is pressed once, the event signal generating unit outputs an event signal 4H different from the other signals from the transmitting section 4G. It is to be noted that there are various ways to press the left event button 4E and the right event button 4F. Other than the above-described ways, for example, there is also a way to keep on pressing the left event button 4E.

Preferably, the format of the operation signal 6A is the same as that of the mouse (not illustrated) of the information processing unit 2, as in the foregoing embodiment.

The receiving section 90 receives the event signal 4H output from the laser pointer 8. The receiving section 90 outputs the received event signal 4H as the event signal 90A to the control section 80.

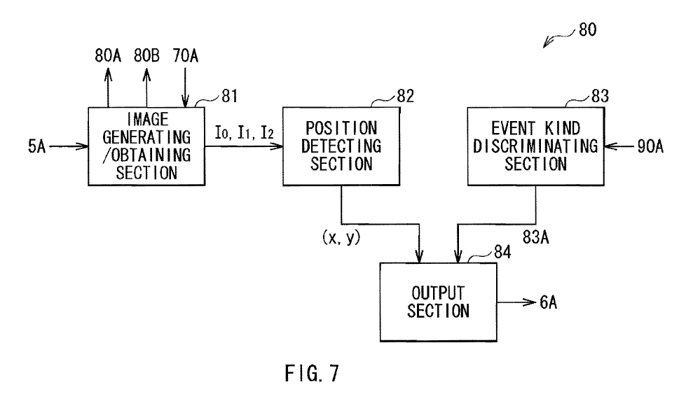

As illustrated in FIG. 7, the control section 80 includes, for example, four function blocks, and has the image generating/obtaining section 81, the position detecting section 82, the event kind discriminating section 83, and the output section 84 as in the foregoing embodiment. In the present embodiment, the position detecting section 82 only outputs the position (x, y) on the projection image Io of the light spot S to the output section 84, and does not output any signal to the event kind discriminating section 83. In addition, the event kind discriminating section 83 receives an event signal 90A output from the receiving section 90, and does not receive any signal from the position detecting section 82.

The event kind discriminating section 83 of the present embodiment, when the position (x, y) on the projection image Io of the light spot S is detected by the position detecting section 82, discriminates the kind of an event on the basis of the event signal 90A output from the receiving section 90, for example. The kind of an event is, for example, one press of the left event button 4E, two presses of the left event button 4E, one press of the right event button 4F, and the like. The event kind discriminating section 83 outputs information 83A of the kind of an event obtained by the discrimination to the output section 84.

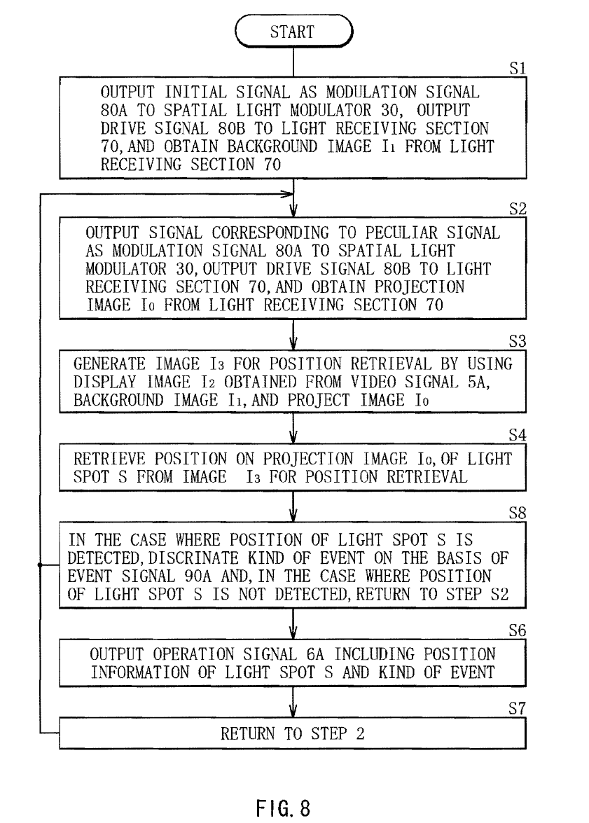

Next, with reference to FIG. 8, an example of the operation of the image display system of the second embodiment will be described. FIG. 8 illustrates a case of using the background image I₁ as an example of a process of discriminating the position of the light spot S and the kind of the event in the image display system. It is to be noted that in a case where the background image I₁ is not used, step S1 which will be described later may be skipped and the image I₃ for position retrieval may be generated without using the background image I₁ in step S3 which will be described later.

First, the control section 80 executes each of the steps S1 to S4 described in the foregoing embodiment. Then, in the case where the position (x, y) on the projection image Io of the pointing part is detected by the position detecting section 82, the event kind discriminating section 83 in the control section 80 discriminates the kind of an event on the basis of the event signal 90A output from the receiving section 90 (step S8). In the case where the position (x, y) on the projection image Io of the pointing part is not detected by the position detecting section 82, control of the control section 80 returns to the step S2 (step S8).

Subsequently, the control section 80 executes each of the steps S6 and S7 described in the foregoing embodiment. Thereafter, the information processing unit 2 performs a process based on the operation signal 6A input from the projector 7 as in the foregoing embodiment. As a result, the information processing unit 2 turns a page, executes the function assigned to an icon, or moves a mouse pointer to the position (x, y).

Accordingly, in the present embodiment, the screen 3 is capable of being used substantially as the touch screen by operating the laser pointer 4 like the mouse (not illustrated) of the information processing unit 2. Thus, for example, the user does not have to move to a position in front of a personal computer to operate the personal computer when the user makes a presentation while pointing a predetermined position in the screen with a laser pointer. Therefore, the user does not have to move between the screen and the personal computer repeatedly during the presentation. Hence, the user is able to smoothly perform the presentation in which the projector is used.

Also, in the present embodiment, it is possible to use the screen 3 substantially as the touch screen without changing the information processing unit 2 and the screen 3. Thus, general versatility and convenience are extremely high. In addition, the configuration of the projector 7 of the present embodiment is obtainable only by providing an existing projector with the reflection light splitting section 50, the light receiving section 70, the control section 80, and the receiving section 90. Therefore, upgrading is easy and the cost required for the upgrading is low.

Although the present invention has been described with reference to the two embodiments, the invention is not limited to the foregoing embodiments but may be variously modified.

For example, in each of the foregoing embodiments, the reflection light splitting section 50 is provided separately from the spatial light modulator 30. However, the reflection light splitting section 50 may be provided integrally with the spatial light modulator 30 or may be provided so as to also serve as the spatial light modulator 30. In such a case, the internal space of the projectors 1 and 7 is reduced, so that the projectors 1 and 7 are miniaturized.

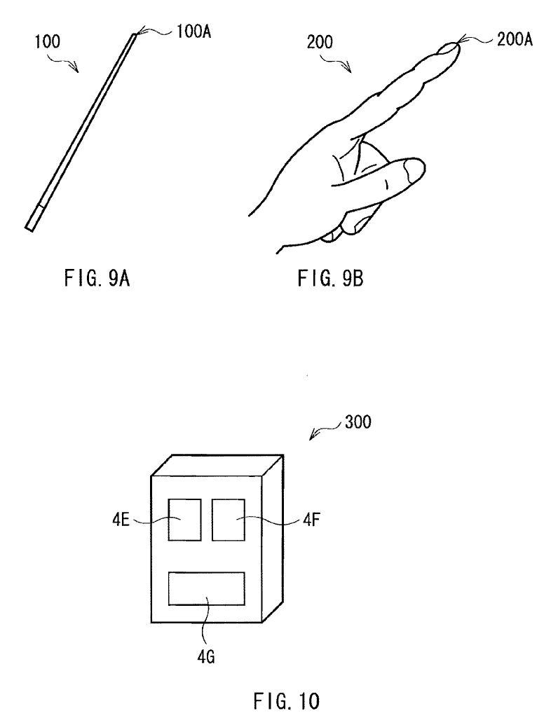

Also, in the foregoing embodiments, although the case of using the laser pointers 4 and 8 as a pointer for pointing a predetermined position on the projection image Io projected on the screen 3 has been described as an example, it is not limited thereto. For example, as illustrated in FIG. 9A, a tip 100A of a pointing stick 100 may be used as the pointer for pointing a predetermined position on the projection image Io projected on the screen 3. In addition, for example, as illustrated in FIG. 9B, a tip 200A of a finger 200 may be used as the pointer for pointing a predetermined position on the projection image Io projected on the screen 3. In this case, for example, it is desirable that an event signal generating unit 300 as illustrated in FIG. 10 be newly prepared, or an unit having a function similar to that of the event signal generating unit 300 be attached to the pointing stick 100.

The event signal generating unit 300 has a configuration similar to that of the event signal generating unit in the laser pointer 8 in the second embodiment, and has, for example, the left event button 4E, the right event button 4F, and the transmitting section 4G. In the case where the event signal generating unit 300 is newly prepared, the kind of the pointer for pointing a predetermined position on the projection image Io projected on the screen 3 will not be limited. Therefore, the general versatility and the convenience are further increased.

The present application contains subject matter related to that disclosed in Japanese Priority Patent Application JP 2008-240245 filed in the Japan Patent Office on Sep. 19, 2008, the entire content of which is hereby incorporated by reference.

Obviously many modifications and variations of the present invention are possible in the light of the above teachings. It is therefore to be understood that within the scope of the appended claims the invention may be practiced otherwise than as specifically described.

What is claimed is:

1. An image display device comprising:
an image light generating section generating image light based on an input video signal;
a projecting section projecting the image light onto a screen to form a projection image;
a reflection light splitting section transmitting the image light from the image light generating section and splitting part of reflection light of the projection image from the screen to a direction crossing the axis of the projecting section;
a light receiving section receiving light split by the reflection light splitting section;
an image generating/obtaining section generating a display image from the video signal and obtaining the projection image corresponding to the inputted video signal from the light receiving section;
a position detecting section detecting a position pointed out on the projection image as a pointed position based on the display image and the projection image; and
an output section outputting information of the pointed position on the projection image.

2. The image display device according to claim 1, wherein the position detecting section detects the pointed position on the projection image based on a differential image as a difference between the display image and the projection image.

3. The image display device according to claim 1, wherein the image generating/obtaining section inputs an initial signal representing a blank image into the image light generating section, independent of the input video signal, to obtain a background image projected on the screen in correspondence with the initial signal, and
the position detecting section detects the pointed position based on the display image, the background image, and the projection image.

4. The image display device according to claim 3, wherein the position detecting section detects the pointed position based on a differential image as a difference between an image obtained by adding the background image to the display image and the projection image.

5. The image display device according to claim 3, wherein the position detecting section detects the pointed position based on a differential image as a difference between the display image and an image obtained by subtracting the background image from the projection image.

6. The image display device according to claim 3, wherein the position detecting section generates an image for position detection with use of the display image, the background image, and the projection image to detect the pointed position on the projection image,
the image display device further comprising an event kind discriminating section discriminating the kind of the event based on information at a position on the image for position detection, the position corresponding to the pointed position on the projection image, and
the output section outputs information of the pointed position on the projection image and information of the kind of the event.

7. The image display device according to claim 6, wherein the event kind discriminating section discriminates the kind of an event based on frequency information at a position on the image for position detection, the position corresponding to the pointed position on the projection image.

8. The image display device according to claim 6, wherein the output section outputs the information of the pointed position on the projection image and the information of the kind of the event, in a format same as that employed in a computer mouse.

9. The image display device according to claim 3, further comprising:
a receiving section for receiving the event signal from an event signal generating unit for selectively generating one or more kinds of event signals; and
an event kind discriminating section, in the case where the position on the projection image of the pointing part is detected by the position detection section, for discriminating whether the event signal is received by the receiving section or not, and when the event signal is received by the receiving section, discriminating the kind of the event signal,
wherein the output section outputs information of the pointed position on the projection image and information of the kind of the event.

10. The image display device according to claim 9, wherein the output section outputs the information of the pointed position on the projection image and the information of the kind of the event, in a format same as that employed in a computer mouse.

11. The image display device according to claim 1, wherein the image light generating section comprises:
a light source;
an optical path splitter separating light emitted from the light source into a plurality of color lights in different wavelength bands and splitting optical paths of the plurality of color lights;
a spatial light modulator modulating each of the plurality of color lights to generate modulated light for each of the color lights; and
a synthesizer synthesizing the plurality of modulation lights to generate the image light.

12. The image display device according to claim 11, wherein the reflection light splitting section is disposed between the synthesizer and the projecting section.

13. The image display device according to claim 11, wherein the reflection light splitting section is formed integrally with the synthesizer.

14. The image display device according to claim 1, wherein the reflection light splitting section is a polarization beam splitter.

15. The image display device according to claim 1, wherein the pointed position on the projection image is pointed out with a laser beam spot from a laser pointer, tip of a pointing stick, or tip of a finger.

16. A position detecting method comprising the steps of:
projecting image light based on an input video signal onto a screen to form a projection image, splitting part of reflection light of the projection image from the screen to another direction, and then receiving split light;
generating a display image from the video signal and obtaining the projection image corresponding to the inputted video signal from split light; and
detecting a position pointed out on the projection image as a pointed position based on the display image and the projection image, to output information of the pointed position on the projection image.
